(19) United States
(12) Patent Application Publication
(10) Pub. No.: US 2026/0021891 A1
(43) Pub. Date: Jan. 22, 2026

(54) COMPUTER IMPLEMENTED METHOD TO PREVENT A NON-VIABLE STATE OF LOADING IN AN AIRCRAFT

(71) Applicant: AIRBUS OPERATIONS, S.L.U., Madrid (ES)

(72) Inventor: Alejandro FIESTRAS CORCHO, Getafe (ES)

(21) Appl. No.: 19/276,466

(22) Filed: Jul. 22, 2025

(30) Foreign Application Priority Data
Jul. 22, 2024 (EP) 24382793.8

(51) Int. Cl. B64D 9/00; G01G 19/414; G01M 1/14

(52) U.S. Cl. CPC B64D 9/003; G01G 19/414; G01M 1/14

(57) ABSTRACT

A computer implemented method to prevent a non-viable state of loading in an aircraft before the aircraft is loaded. Given a layout of the load space and a set of load units, the method estimates the state of loading and prevents loads that would be non-viable once the aircraft is loaded.

### RELATED APPLICATION

This application incorporates by reference and claims priority to European Patent Application EP24382793.8, filed Jul. 22, 2024.

### FIELD OF THE INVENTION

The present invention is related to a computer implemented method to prevent a non-viable state of loading in an aircraft before the aircraft is loaded. Given a layout of the load space and a set of load units, the method estimates the state of loading and prevents loads that would be non-viable once the aircraft is loaded.

### BACKGROUND

One of the most serious flight safety problems in an aircraft is the lack of balance due to inadequate load distribution in the aircraft's cargo space.

The loads on board an aircraft are placed in pre-established spaces to allow the load to be distributed as evenly as possible. However, each load has a different value depending on its weight, and its distance from the aircraft central axil (the axis parallel to the roll axis) defines a lateral momentum which is equal to the value of the weight times the distance to the axis. In an ideal situation the lateral momentum of one load must be compensated by the lateral momentum of another load.

The cargo space of an aircraft is usually distributed in rows. In each row there are a plurality of cargo spaces and all of them can be separated into two groups, the spaces on one side of the symmetry axis or central axis and those on the other side. Depending on how the orientation is arbitrarily chosen, one side will be on the right and the other side on the left, for example according to a top plan view.

In some cases, some of these rows have the spaces corresponding to half a row disabled. This creates a problem because, when the available spaces are loaded on the other side of the same row, each of the load units generates a lateral momentum that is not compensated. A row in this condition will be named an empty row.

It is possible for an empty row to be compensated, at least partially, by another empty row in which the empty spaces are on the opposite side. However, it is of interest especially in the case where there is no such compensation.

One might think that, knowing the layout of the aircraft, the empty rows and their position and the loads to be installed in the cargo space, it is possible to pre-distribute the position of each cargo unit in order to minimize the lateral momentum of the entire load. However, this is not possible because it is not known a priori which rows are empty and what weight each individual load has.

At best, it is usual to estimate at the time of loading which loads are heavier and which are not, and then the person in charge of distributing the load can make use of this arrangement when carrying loads on either side of the central axis.

However, it is not established a control that prevents starting the loading process of an aircraft because without this information it establishes the condition of viability or non-viability of the load. A total load lateral momentum is considered to result in a viable load when it does not exceed a maximum value of the lateral momentum determined for each aircraft. The present invention overcomes this problem by making a plurality of simulations of loads and, depending on the results of the simulation stablishes a viability or a non-viability state preventing the loading process when the state is non-viable.

### SUMMARY OF THE INVENTION

The present invention is a computer implemented method to prevent a non-viable state of loading in an aircraft.

The method provides information that is subsequently processed checking if the aircraft can be loaded or not according to the state. That is, if the state is “viable” then the aircraft is loaded but if the state is “non-viable” then the aircraft is not loaded. The state “viable” or “non-viable” may be represented by binary variables or by more complex structures having additional information like the estimated balance of the load.

The load to be loaded in the aircraft comprises a plurality of load units.

The method, according to a first aspect of the invention comprises the steps in any order:
receiving data of a layout of a load space of the aircraft, the layout comprising: (a) a set of N rows, each row comprising a set of M locations, the M locations with a subset of left location/s and a subset of right location(s); and (b) for each location the distance of the location to an axis of symmetry for measuring lateral momentums of loads, the axis of symmetry is parallel and vertically aligned with a roll axis of the aircraft;
receiving a maximum load unbalanced lateral momentum value;
receiving a probability function or a probability distribution of the weights for the load units; and
predetermining a maximum number of empty rows R to be checked, being an empty row is a row where one side, the right side or the left side, is locked preventing the locations of said selected rows to be loaded while the opposite side is unlocked allowing to be loaded.

The layout of the load space of the aircraft identifies the locations where a load unit may be positioned. The load space is distributed in rows, each row having one or more locations at a right side of a central axis of symmetry, the axis of symmetry being parallel and vertically aligned with the roll axis of the aircraft. Any load placed at a distance from this axis of symmetry causes a lateral momentum equal to the weight of the load multiplied by the distance from the axis of symmetry.

Each row has one or more locations at the right side and one or more locations at the left side, wherein right and left are selected, only as a reference for this description, as the right and left sides according to a plan view.

The method further comprises receiving information about the maximum load unbalanced lateral momentum allowed for the specific aircraft associated with the layout. This maximum value will be used as the reference value to check whether or not the estimated value of the load unbalance lateral momentum is allowable (viable) or not.

As previously mentioned, an empty row will identify a row where one side of the row is locked and cannot be loaded. This is the case when the fixing means is broken or there is some specific reason that prevents that side of the row from being used to store the load unit. The fixing means is a mechanism that fixes the load to the aircraft.

In this first aspect of the invention, the relevant empty rows are those that are at the same side, since empty rows with the locked side being the opposite can be compensated. That is, the number of empty rows that cause un unbalanced lateral momentum are those that are at the same side.

The method estimates the lateral momentum for an unbalanced load when the layout has no empty rows, when there is one empty row, or when there are two empty rows, etc., until a maximum number of empty rows R.

The method according to the first aspect of the invention further comprises the steps: for i=0, 1, . . . , R, carry out a plurality of simulations of loading the load space according to the received layout, wherein for each simulation randomly selecting i rows as empty rows, such empty rows being empty at the same side; and determining the weight of each unlocked location as a random value responsive to the probability function or the probability distribution of the weight generating a random load distribution.

These steps randomly select rows that are empty (with locked load locations at one side, and all the selected rows with locked load locations at the same side), and randomly populate load units according to a predetermined probability function. It has been indicated that the weight of each unlocked location is responsive to the probability function or the probability distribution since the probability function is defined by its probability distribution and, the probability distribution is defined by its probability function.

Likewise, it is considered equivalent to use other ways of representing the probability of the value of a unit load, for example as a percentage of weight with respect to the maximum weight to be loaded.

As a result of these steps, for each number of empty rows a plurality of statistically estimated distribution of weights over the entire layout is available. That is, for each number of empty rows, there is a plurality of statistical distributed loads causing a different lateral momentum.

The method according to the first aspect of the invention further comprises the steps for each i=0, 1, . . . , R:
generating a random load distribution by accumulating a plurality of simulated random load distributions with i empty rows;
determining the lateral momentum of the accumulated distribution of the load in respect to the axis of symmetry with i empty rows;
determining the state of loading in an aircraft with i empty rows as viable if the unbalanced lateral momentum measured on the accumulated random load distribution of previous step is lower than maximum load unbalanced lateral momentum value or as non-viable otherwise; and
providing data to be processed when loading the aircraft identifying load distributions to be prevented as those with the state as non-viable responsive to the number of empty rows.

In this set of steps, first and for each number of empty rows, a load distribution is generated as a result of accumulating all the distributions obtained randomly in the previous steps. That is, instead of having a plurality of random experiments, a single distribution is obtained. It is this distribution that allows the calculation of the lateral momentum with respect to the symmetry axis, and this calculation is repeated for each number of empty rows.

For each number of empty rows, the lateral momentum it generates is calculated and compared with the maximum value. As a result, there are as many comparisons as the number of empty rows simulated. Each result for a number of empty rows is independent of the result for a different number of empty rows.

These results are provided by the method so that the information is sent to the device or processor in charge of establishing the safety of the aircraft at the time of loading.

At the time of loading, it is known how many rows are empty rows. From the information provided by the method according to the first aspect of the invention the calculated state for that number of empty rows is verified and, if the calculated state is non-viable then the aircraft is not loaded since it is estimated that the loading would result in a lateral momentum along the roll axis greater than that permitted. If, on the other hand, for that number of empty rows, the value of the state is “viable” then the aircraft is allowed to be loaded and the loading process proceeds. That is, the information is used by the next step to establish whether the aircraft is loaded in a way that ensures a safe flight or not.

According to an embodiment of the previous disclosed method, for the selected i rows the steps of randomly selecting empty rows and determining the weight of each unlocked location is executed a plurality of times to generate a plurality of random load distributions that are subsequently accumulated into a single random load distribution. Each of the execution may be done with different set of empty rows.

According to this embodiment, the same number of empty rows may have different locations and, in this embodiment a plurality of combinations of locations for the empty rows is explored providing an enriched distribution that is subsequently accumulated. This allows to identify distributions where the location of the empty rows may provide a different result. This is the case for instance where the rows have different space distribution of the load locations and the, selecting a different row as empty row will cause a different lateral momentum even for the same weight.

According to a further embodiment of any of the previous disclosed embodiments R=N.

In this particular embodiment all cases are explored wherein even the entire airplane has empty rows. In this case method provides information for any possibility of layout.

According to a further embodiment of any of the previous disclosed embodiments, it is further determined the weight of each unlocked location as a random value responsive to the probability function or the probability distribution of the weight for a load unit is according to the following steps:
generating a list of weights for the total number of unlocked locations according to the probability function or the probability distribution;
sorting the generated list; and
for each row, assigning the loads to unlocked locations from the list according to the sorted order minimizing the unbalanced lateral momentum per row.

In either case, whenever it is stated that a value of the weight of a unit load is assigned responsive to the probability density function, it should be interpreted as taking a random value according to the probability density function or the probability distribution.

In some real situations, the operators in charge of loading the aircraft decide to arrange the loads by weight and distribute rows using ordered weights, for example alternating on one side and the opposite side, in opposite positions and at the same distance, to carry out a load that reduces the lateral momentum of loads with very different weights. If the weights of two unit loads are very different then, since the sorting process groups unit loads with close weights, such two load would be in different rows and would be at least partially compensated with the weight of other load unit with a close weight.

This action reduces the resulting lateral momentum of the whole set of load units and is introduced into the simulation process but, as the loads are not known, the sorting process is carried out on the whole set of weights, said weights randomly determined by sampling the probability density function. In this case the number of situations leading to non-viable states is expected to be smaller.

A second aspect of the invention is a data processing system comprising a processor configured to perform the steps of a method according to the first aspect of the invention or, to any of the embodiments of the first aspect of the invention.

A third aspect of the invention is a computer program product comprising instructions which, when the program is executed by a computer, cause the computer to carry out the steps of a method according to the first aspect of the invention or, to any of the embodiments of the first aspect of the invention.

### SUMMARY OF THE DRAWINGS

These and other features and advantages of the invention will be seen more clearly from the following detailed description of a preferred embodiment provided only by way of illustrative and non-limiting example in reference to the attached drawings.

FIG. 1 shows an embodiment of layout that is being processed by a processor in order to estimate the lateral momentum or torque generated by the lack of load balance with respect to the aircraft's roll axis when the space of load has two empty rows.

FIG. 2 shows schematically the loading process of an airplane where the method provides a security system preventing to load estimated as a load non-viable.

### DETAILED DESCRIPTION

As will be appreciated by one skilled in the art, aspects of the present invention may be embodied as a system, method or computer program product.

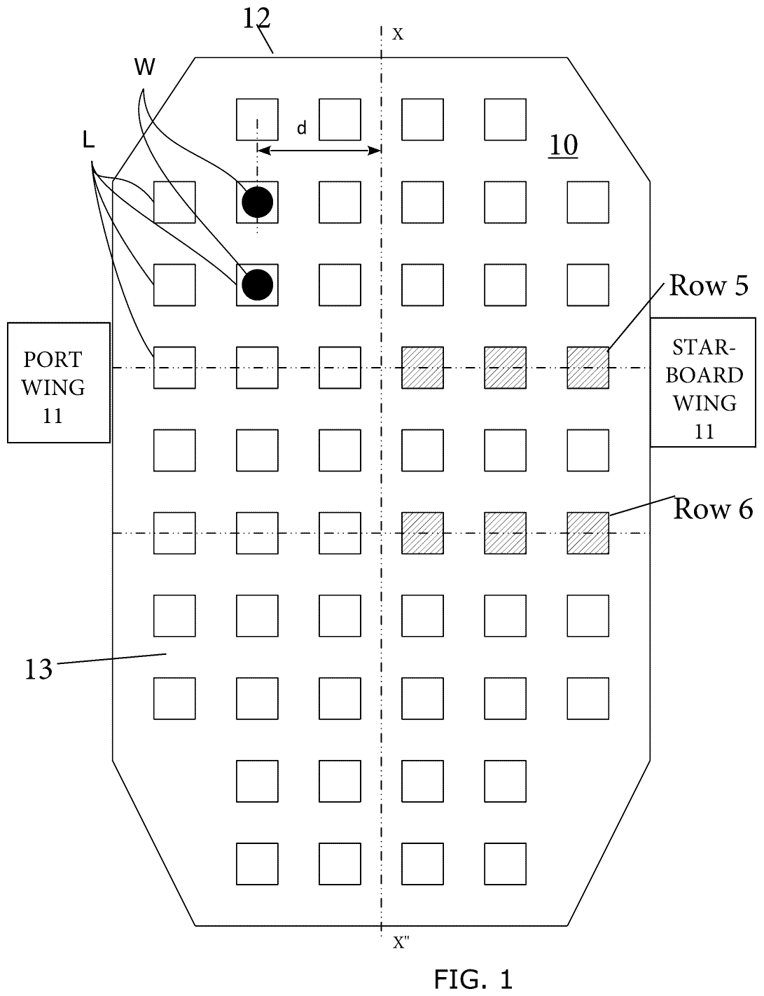

According to an embodiment of the method, there is a first step receiving data, in this case through a data line, providing a request of state of viability of load for an airplane. As FIG. 1 shows, along the information, the layout of the space of load (10) within an airplane shows those locations (L), e.g., seats or cargo locations, where a load unit (W), e.g. passenger or cargo, may be placed and fixed. The layout schematically shows the locations (L) as squares and, if a load unit (W) is located centered in the location (L), the load unit (W) causes a lateral momentum in respect to a symmetry axis (X-X′), the symmetry axis (X-X′) being parallel to the roll axis of the airplane. The summation of the lateral momentums of all unit loads (W) is the one that must be compensated for by the wings (11) and therefore, depending on the airplane, a maximum lateral momentum of the whole load is stablished in order to ensure the safety of the airplane.

The space of the load (10) may be within a fuselage (12) of the aircraft and may be a seating area in the cabin (13) for passengers in a passenger aircraft, cargo bay underneath or behind the seating area in a passenger aircraft or cargo bay in a cargo aircraft. For a passenger aircraft, the load unit (W) may be whether a passenger sitting in a seat at the load location (L).

At this stage only the number of locations and the total load to be loaded is known and therefore it is defined that each load unit (W) statistically shows a Gaussian distribution of mean equal to the total load divided by the number of available locations and a predetermined variance.

FIG. 1 also shows two load units (W) already installed and that the lateral momentum of one of them is calculated as the weight of the load unit (W), estimated randomly sampling a Gaussian probability function, multiplied by the distance (d) from the center of mass to the axis of symmetry.

The maximum number of lateral momentum and the maximum number of empty rows R is also received as data.

The method generates a plurality of simulations for each i=0, 1, . . . , R, by: randomly selecting i rows as empty rows, such empty rows being empty at the same side; and/or determining the weight of each unlocked location as a random value responsive to the probability function or the probability distribution of the weight generating a random load distribution;

In one of these steps, when i=2, two empty rows are selected: the empty row 5 starting to count rows from the row at the top of the figure, and empty row 6 wherein the two selected empty rows are not allowed to be loaded at the right side. The locked locations (L) are identified by dashed squares.

Once the simulation has sampled the weight for each unlocked location (L) such simulation is repeated a plurality of times allowing to obtain an aggregated or accumulated statistical distribution. This resulting accumulated statistical distribution is used to compute the unbalanced lateral momentum that is identified for i=2.

If the unbalanced lateral momentum is larger than the maximum lateral momentum allowed for the airplane, then the status for i=2 is determined as being non-viable.

The same procedure is repeated for the other i values.

According to another embodiment, the accumulated distribution is enriched since the two selected rows is randomly selected a plurality of times providing information of a plurality of cases where, for instance, the selected row has different conditions. This is the case of the first row or, the two rows located and the end where the number of locations (L) at each side is lower and closer to the symmetry axis.

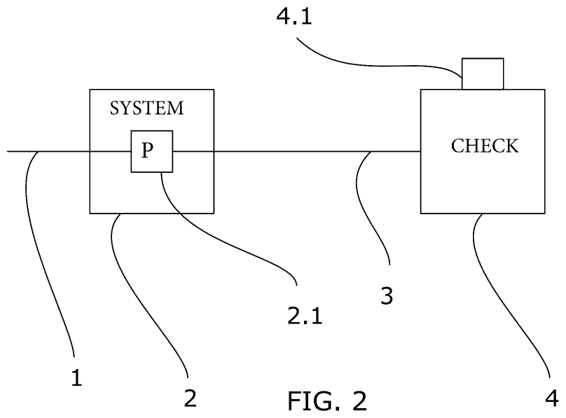

FIG. 2 shows an input line (1) providing the initial data to a system (2) comprising a processor (P) (2.1) adapted to carry out a method according to the first aspect of the invention and, an output line (3) connected to a checking system (4) where the operator assigned to control the loading of the aircraft indicates which rows are empty rows (show by the two starboard side rows marked with cross-hatching) and, in view of the information provided by the system (2) verifies the status for that number of empty rows.

The processor may be configured, e.g., programmed to perform the steps of the methods described herein. For example, the processor may:
receive data of a layout of an aircraft load space having a port side and a starboard side separated by an axis of symmetry (X-X′) aligned with roll axis of the aircraft, wherein the layout includes N rows each having M locations (L) in the load space distributed as a first subset of port locations (L) on a port side of the load space and a second subset of starboard locations (L) on a starboard side of the load space, and the data includes for each of the locations location (L) a distance between the location (L) and the axis of symmetry (X-X′);
receive a maximum load unbalanced lateral momentum value associated with the aircraft;
receive a probability function or a probability distribution of a weight for each of a plurality of load units (W);
predetermine a maximum number of empty rows (R) to be checked, wherein an empty row has the port side or the starboard side locked such that the locations (L) in the port side or the starboard side of the row are not to be loaded, and the other of the port side or starboard side of the row is unlocked to allow loads to be placed in the locations (L) of unlocked the port side or the starboard side of the row;
for i=0, 1, . . . , R rows, carry out a plurality of simulations of loading the load space according to the received layout, wherein for each simulation
randomly selecting i rows as empty rows, wherein the selected empty rows are all on the port side or on the starboard side;
determine a weight of each unlocked location (L) as a random value responsive to the probability function or the probability distribution of the weight generating a random load distribution;
for each i=0, 1, . . . , R, generating a random load distribution by accumulating the plurality of simulated random load distributions with i empty rows;
determining the lateral momentum of the accumulated distribution of the load in respect to the axis of symmetry (X-X′) with i empty rows;
determining the state of loading in an aircraft with i empty rows as viable if the unbalanced lateral momentum measured on the accumulated random load distribution of previous step ii) is lower than maximum load unbalanced lateral momentum value or, as non-viable otherwise;
providing data to be processed when loading the aircraft identifying load distributions to be prevented as those with the state as non-viable responsive to the number of empty rows.

The providing of the data may be in the form of a graphical icon representing the rows and locations for cargo or passengers in rows shown in FIG. 1. The graphical icon identifies empty rows and locations at which cargo or passengers are placed or are to be placed. The graphical icon may have a green background color indicating an viable load distribution and a red background indicating that the loading is not viable. The graphical icon may be presented on a display in the cockpit of the aircraft, or on a

When the status is non-viable, an alarm (4.1) is triggered and the aircraft is prevented from loading in these circumstances, preventing it from flying in unsafe conditions. Alarm (4.1) may disable a function of the aircraft necessary for take-off such that the aircraft is prevented from take-off until the status is changed from non-viable to viable.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both, unless the disclosure states otherwise. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A computer implemented method to prevent a non-viable state of loading in an aircraft, the load to be loaded a load units in the aircraft, the method comprising:
a) receiving data of a layout of a load space of the aircraft, the layout comprising
a set of N rows wherein each of the N rows comprises M locations wherein a first subset of the locations are on a left side of the aircraft and a second subset of locations is on a right side of the aircraft, wherein the left side and the right side are separated by an axis of symmetry that is parallel to an vertically aligned with a roll axis of the aircraft, and
a distance for each of the locations between the location and the axis of symmetry;
b) receiving a maximum load unbalanced lateral momentum value;
c) receiving a probability function or a probability distribution of weights for the load units;
d) predetermining a maximum number of empty rows R of the N rows, wherein each of the empty rows has empty locations on either the right side or the left side but not both and the empty locations are locked to prevent loading at the empty locations;
e) for i =0, 1, . . . , R, number of the empty rows, perform a simulations of loading the load space according to the received layout, wherein for each of the simulations:
1) randomly select i rows as empty rows, wherein the empty rows are all empty on the right side or the left side;
2) determining the weight of each unlocked location of the locations on the rows as a random value responsive to the probability function or the probability distribution of the weight generating a random load distribution;
f) for each of the i=0, 1, . . . , R,
i. generating a load distribution having the i empty rows by accumulating the simulated random load distributions with the i empty rows;
ii. determining the lateral momentum of the load distribution having the i empty rows, wherein the lateral momentum is relative to the axis of symmetry; and
iii. determining whether a state of loading in the aircraft with the load distribution having the i empty rows is viable or non-viable based on whether the corresponding lateral momentum is lower than the maximum load; and
g) providing data to be processed when loading the aircraft identifying the load distributions to be prevented if the determined state is non-viable.

2. The computer implemented method according to claim 1, further comprising loading the aircraft based on the data to be processed when loading the aircraft.

3. The computer implemented method according to claim 1, wherein for the selected i rows in the randomly selected i rows, the determining of the weight of each of the unlocked locations is executed a plurality of times generating a plurality of random load distributions that are subsequently accumulated into a single random load distribution.

4. The computer implemented method according to claim 1, wherein the steps 1) and 2) are executed a plurality of times randomly selecting a different set of empty rows.

5. The computer implemented method according to claim 1, wherein R=N.

6. The computer implemented method according to claim 1, wherein the determining a weight associated with each of the unlocked locations as a random value responsive to the probability function or the probability distribution of the weight for a load unit is according to:
generating a list of loads for a total number of the unlocked locations according to the probability function or the probability distribution;
sorting the generated list; and
for each of the rows, assigning the loads to the unlocked locations from the list according to a sorted order reducing the unbalanced lateral momentum per row.

7. A data processing system comprising a processor configured to perform the steps of the computer implemented method of claim 1.

8. A computer program product comprising instructions which, when the program is executed by a computer, cause the computer to carry out the steps of the computer implemented method of claim 1.

9. A computer implemented method to assist in loading cargo units in an aircraft, the method comprising:
receiving a layout of cargo locations in the aircraft, the layout including: rows each having a certain number of the cargo locations grouped into a first subgroup of the cargo locations on a port side of a roll axis of the aircraft and a second subgroup the cargo locations on a starboard side of the roll axis, wherein the data indicates for each of the cargo locations a distance between the cargo location and the roll axis;
receiving a maximum load unbalanced lateral momentum value for the aircraft;
receiving or using a probability function or a probability distribution of weights for the cargo or passengers:
determining a maximum number of empty rows of the rows, wherein the cargo locations on each of the empty rows are locked to be unavailable to receive the cargo units on either the portside or the starboard side while the cargo locations on the opposite side are unlocked to receive the cargo units;
performing simulations of load distributions of the load space according to the received layout wherein each of the simulations has a respective number of the empty rows from 1 to the maximum number of empty rows, wherein for each of the simulations:
randomly selecting one or more of the rows as empty rows, wherein all of the empty rows are empty uniformly either along the portside or the starboard side; and
determining a weight of cargo to be loaded on each of the cargo locations that are unlocked as a random value responsive to a probability function or a probability distribution of weights of the loads to be placed at unlocked cargo locations of the cargo locations to generate a random load distribution of the cargo loads at the unlocked cargo locations;
generating an accumulated random load distribution by accumulating the plurality of simulated random load distributions;
determining a lateral momentum of the accumulated random load distribution, wherein the lateral momentum is relative to the axis of symmetry;
determining whether a state of loading of the aircraft is viable depending on whether the lateral momentum of the accumulated random load distribution is lower than maximum load unbalanced lateral momentum value; and
providing data to be processed when loading the aircraft identifying load distributions to be prevented based on whether the state of loading for the load distribution is viable or not viable.

10. The computer implemented method recited in claim 9, further comprising:
loading the aircraft in an actual load distribution, and
disabling the aircraft from taking off if the actual load distribution corresponds to one of the load distributions determined to be not viable.
